(19) United States
(12) Patent Application Publication
(10) Pub. No.: US 2010/0269264 A1
(43) Pub. Date: Oct. 28, 2010

(54) Bit structure for powered tools

(76) Inventor: Pan-Ching Huang, Changhua (TW)

Correspondence Address: Guice Patents PLLC, 12647 Galveston Court #302, Manassas, VA, 20112, US

(21) Appl. No.: 11/896,466

(22) Filed: Aug. 31, 2007

(51) Int. Cl. B25F 1/00; B25B 15/00; B23B 27/00

(52) U.S. Cl. 7/169; 81/460; 408/199

(57) ABSTRACT

A bit structure for powered tools includes a shank action end at one end of a bit and a tool gripping section at another end. The shank action end has a conical directing portion formed by extending rearwards from a front edge of the shank action end. The directing portion is extended rearwards to form an expansion bore cutting section between the shank action end and the tool gripping section. The expansion bore cutting section has at one axial cutting edge formed at a length equal to or greater than the maximum diameter of the directing portion. The bit structure thus formed can simultaneously perform multiple functions of drilling holes, expanding holes and fastening screws faster with less time and effort.

### BACKGROUND OF THE INVENTION

1. Field of the Invention

The present invention relates to a bit structure for powered tools and particularly to a bit structure that simultaneously provides multiple functions of drilling holes, expanding holes and fastening screws.

2. Description of the Prior Art

Referring to FIG. 1, a bit 10 for conventional powered tools (such as pneumatic tools or electric driven tools) is rotated by the driving power of the tools to fasten or unfasten a screw 13. Its structure generally includes a shank action end 11 at one end formed in a shape mating a tool slot 132 on a screw head 131 of the screw 13. The shape may be a slot, cross (for Philips heads), star or the like. The shank action end 11 has a distal edge 111 from which a plurality of slant ridges 112 and troughs 113 are formed by extending rearwards. At another end there is a tool gripping section 12 to be gripped by a powered tool. The bit 10 thus formed aims to fasten only screws. In different working conditions different tools have to be prepared and replaced whenever needed. It is not convenient. For instance, to work an expansion screw on a wall panel, first, a drill bit 22 (referring to FIG. 2) has to be gripped by the powered tool to form a working hole 211 on the wall panel 21; then an expansion screw 23 is inserted into the working hole 211 (referring to FIG. 3); the expansion screw 23 has a screw sleeve 231 which has to be expanded and anchored that are generally done through two approaches: one is to draw a bolt head 233 of a bolt 232 by means of a drawing tool 31 (referring to FIG. 4) to expand and anchor the deformed screw sleeve 231 on the wall panel 21. Such an approach has to change two different types of tools (drilling bit and drawing tool). Drawing the bolt head 233 through the drawing tool 31 also takes a great effort. The other approach is forming the working hole 211 on the wall panel 21, then replacing the drill bit 22 on the powered tool with a bit 10 to fasten the bolt 232 against a tool slot 234 of the bolt head 233 (referring to FIGS. 3 and 5); then fastening the screw sleeve 231 through the bit 10 to create expansion and deformation, and form a tight fastening on the wall panel 21. The second approach takes less effort, but incurs the inconvenience of changing two different types of tools.

### SUMMARY OF THE INVENTION

In view of the aforesaid problems, it is an object of the present invention to provide a bit structure for powered tools that simultaneously provides multiple functions of drilling holes, expanding holes and fastening screws. To achieve the foregoing object the bit of invention has a shank action end at one end, a conical directing portion extended rearwards from a distal edge of the shank action end and a tool gripping section at another end. The invention further has the following feature: the directing portion is extended rearwards to form an expansion bore cutting section located between the shank action end and the tool gripping section. The expansion bore cutting section has at least one axial cutting edge formed at a radial length equal to or greater than the maximum diameter of the directing portion. The bit thus formed can simultaneously provide multiple functions of drilling holes, expanding holes and fastening screws at a faster speed with less time and effort.

In one aspect the shank action end of the bit of the invention may be formed in a selected shape such as a slot, cross, star or the like to mate the tool slot formed on the ordinary screw heads.

In another aspect the expansion bore cutting section can perform cutting to form a working hole and also perform hole drilling and expanding functions.

In yet another aspect the expansion bore cutting, section allows the bit to drill a hole and achieve hole expansion through the directing portion and the expansion bore cutting section so that a working hole can be formed on a soft wall panel (such as a gypsum board, wooden panel or the like) at a diameter equal to or greater than the maximum diameter of the directing portion.

In yet another aspect the expansion bore cutting section has at least one cut directing trough originated from a ditch of the directing portion and extended rearwards to the expansion bore cutting section to form a debris discharge portion, and has the cutting edge formed at one side to perform cutting.

In yet another aspect the expansion bore cutting section is located at the rear side of the directing portion. The bit has a shank surface with a second directing portion formed thereon and at least one cut directing trough to discharge debris and the cutting edge at one side to perform cutting.

In yet another aspect the expansion bore cutting section has at least one blade jutting outwards from the bit shank surface that has the cutting edge formed thereon.

In yet another aspect the expansion bore cutting section is located at the rear side of the directing portion, and has the cutting edge jutting from a front edge of one side and at least one cut directing trough formed thereon.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional bit.

FIG. 2 is a schematic view of a conventional work on a wall panel.

FIG. 3 is a schematic view of a conventional work on a wall panel in operating condition-1.

FIG. 4 is a schematic view of a conventional work on a wall panel in operating condition-2.

FIG. 5 is a schematic view of a conventional work on a wall panel in operating condition-3.

FIG. 6 is a perspective view of the invention.

FIG. 7 is a plane view of the invention.

FIG. 8 is a schematic view of the invention in operating condition-1.

FIG. 9 is a schematic view of the invention in operating condition-2.

FIG. 10 is a schematic view of the invention in operating condition-3.

FIG. 11 is a schematic view of the invention in operating condition-4.

FIG. 12 is a plane view of a second embodiment of the invention.

FIG. 13 is a schematic view of the second embodiment of the invention in an operating condition.

FIG. 14 is a plane view of a third embodiment of the invention.

FIG. 15 is a schematic view of the third embodiment of the invention in an operating condition.

FIG. 16 is a plane view of a fourth embodiment of the invention.

FIG. 17 is a schematic view of the fourth embodiment of the invention in an operating condition.

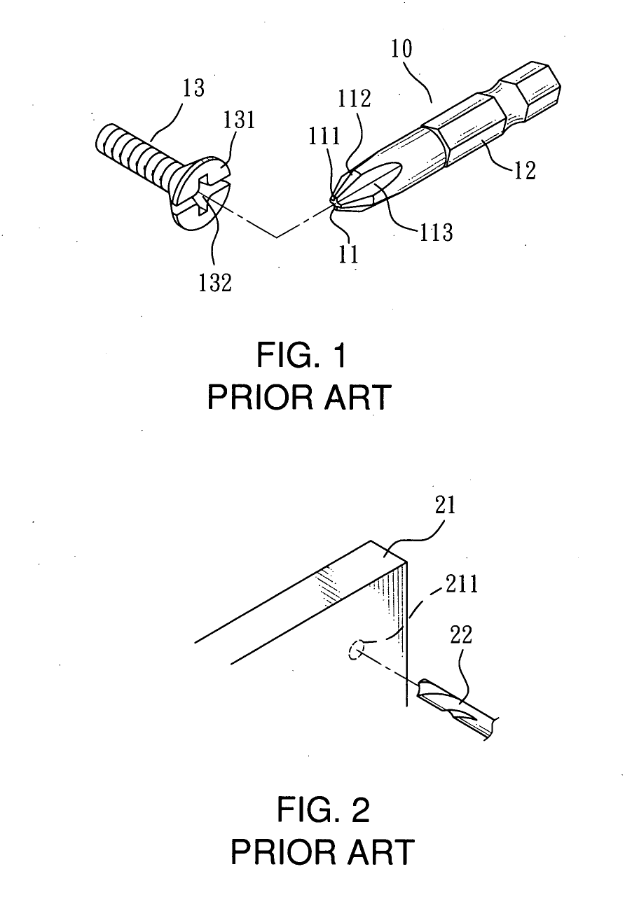

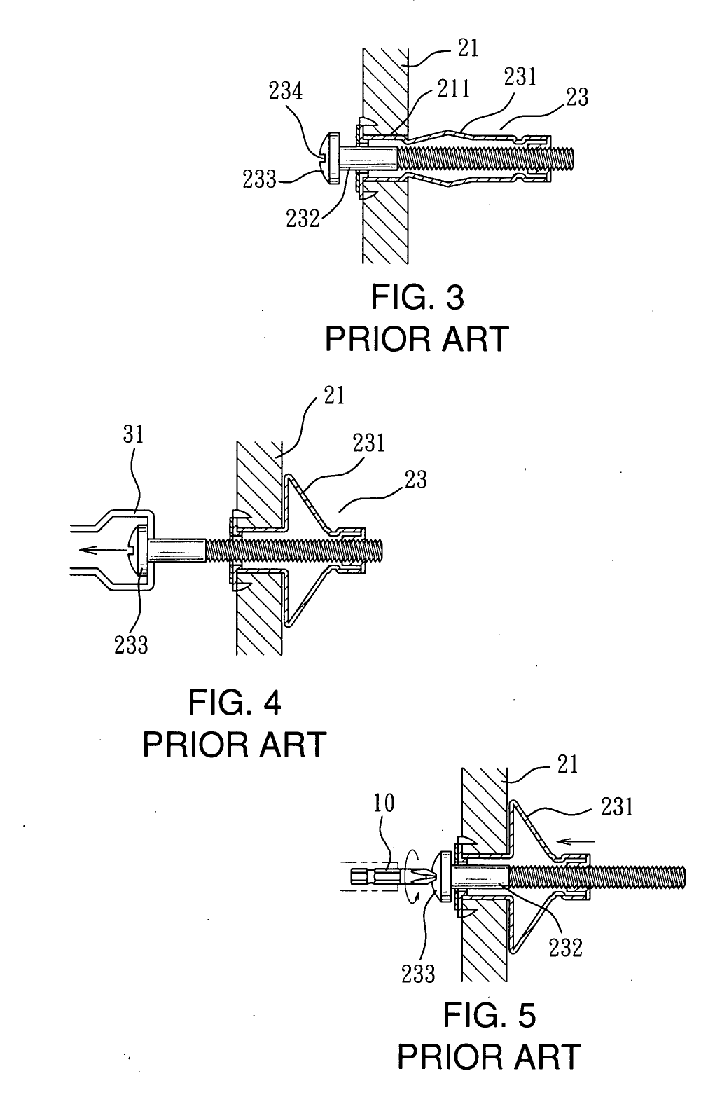

### DESCRIPTION OF THE PREFERRED EMBODIMENTS

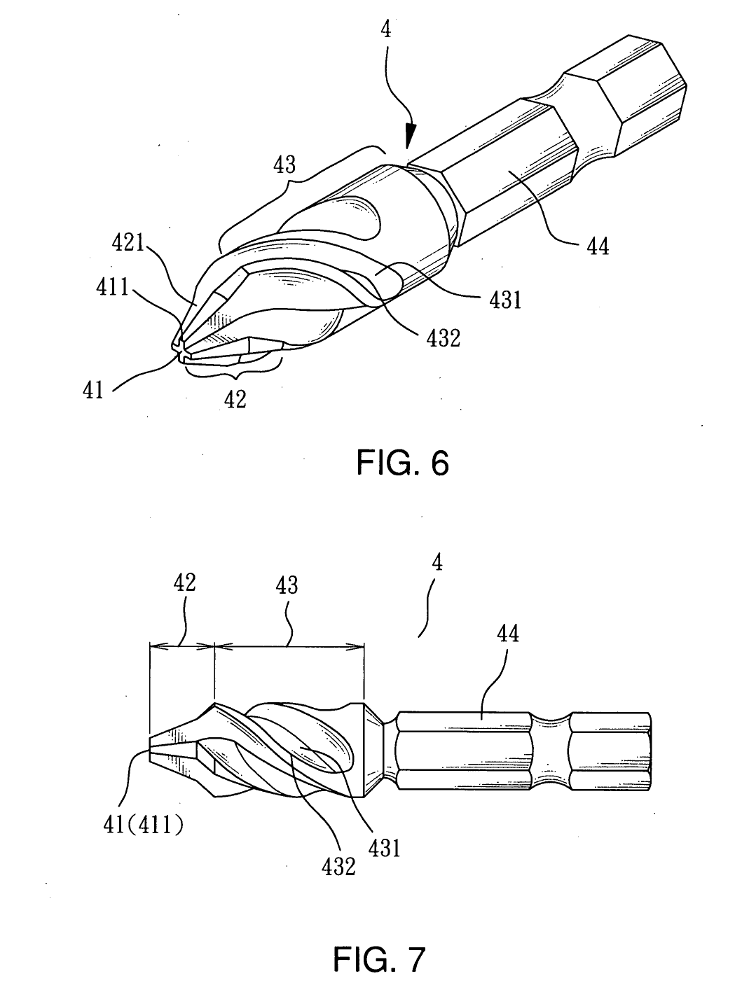

Referring to FIG. 6, the bit 4 for powered tools of the invention has a shank action end 41 at one end formed in a shape mating a tool slot on an ordinary screw head. The shank action end 41 has a distal edge 411 from which a conical directing portion 42 is formed by extending rearwards. The directing portion 42 has at least one ditch 421 and an expansion bore cutting section 43 extended rearwards. The bit 4 has a tool gripping section 44 at another end. The bit thus formed can simultaneously perform multiple functions of drilling holes, expanding holes and fastening screws.

As previously discussed, the invention provides a feature based on the conventional bit structure of power tools by adding an expansion bore cutting section. In addition to the original basic function of fastening screws, the expansion bore cutting section 43 also can provide additional functions of drilling holes and expanding holes. This is especially useful for working on large holes (greater than 6 m/m). Equipped with one bit multiple functions such as drilling holes, expanding holes and fastening screws can be accomplished without changing tools.

The expansion bore cutting section 43 (referring to FIGS. 6 and 7) has at least one cut directing trough 431 originated from the ditch 421 of the directing portion 42 by extending rearwards to the expansion bore cutting section 43 to form a debris discharge portion. It also has a cutting edge 432 at one side to perform cutting function, and formed in a helical fashion on the surface of the expansion bore cutting section 43.

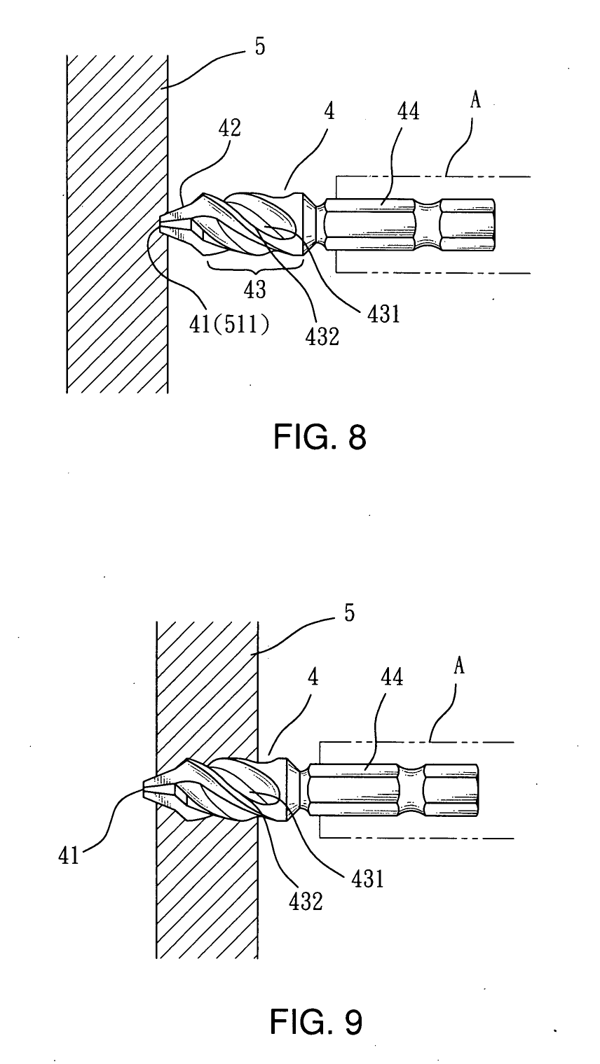

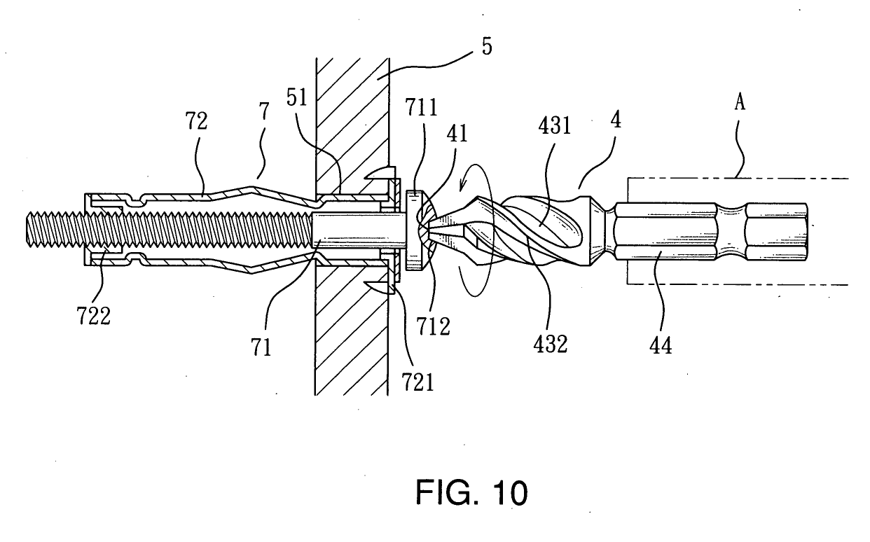

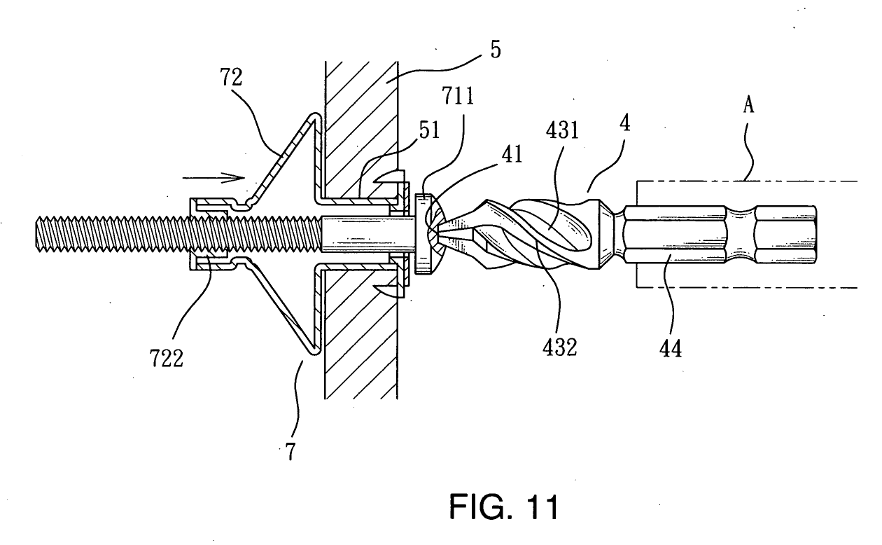

Referring to FIG. 8, when to work on a wall panel 5, first, grip the tool gripping section 44 by a powered tool A; drive the bit 4 to rotate by means of the powered tool A with the shank action end 41 driven into the wall panel 5; under the direction of the distal edge 411 and the adjacent directing portion 42, an insert drilling operation can be performed; next, drilling hole and expanding hole operations can be proceeded through the cut directing trough 431 and the cutting edge 432 of the expansion bore cutting section 43 (referring to FIGS. 8 and 9). As the wall panel 5 is made of a soft gypsum board, wooden panel or the like, and has a hardness much lower than the shank action end 41 of the bit 4, the shank action end 41 can easily enter through an entering point 511 and expand outwards, and drill and cut to form a working hole 51 to receive an expansion bolt 7 (referring FIG. 10). Then the shank action end 41 can be pointed to a tool slot 712 on a screw head 711 of a screw 71 to do screw fastening. The expansion bolt 7 has a screw sleeve 72 with a sleeve head 721 formed thereon. Due to screw fastening operation, the sleeve head 721 can be moved against the wall panel while an internal screw hole 722 engaged with the front end of the screw sleeve 72 and the screw 71 to force the screw sleeve 72 in the inverse direction to expand towards the working hole 51 and anchor tightly on the wall panel 5 (referring to FIG. 11) to finish the entire work operation. The whole process requires only a single bit without changing any tool. Thus the bit 4 of the invention allows the work to be done faster with less effort and time.

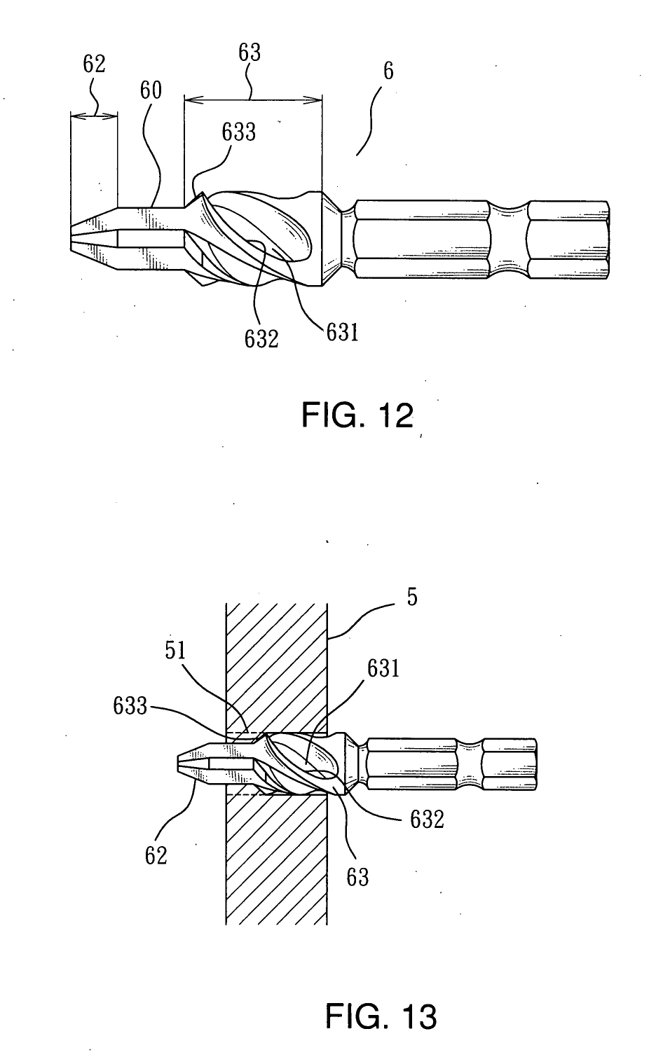

Refer to FIG. 12 for a second embodiment of the invention. It has an expansion bore cutting section 63 located the rear side of a directing portion 62. The expansion bore cutting section 63 has a second directing portion 633 formed thereon by extending the surface of a shank 60 at the rear side of the directing portion 62 and at least one cut directing trough 631 to discharge debris, and a cutting edge 632 at one side to perform cutting operation. Referring to FIG. 13, when a bit 6 is used to form the working hole 51 on the wall panel 5, the second directing portion 633 directs the cutting edge 632 to do drilling hole and expanding hole operations. The debris is discharged through the cut directing trough 631. The working hole 51 thus formed can be inserted by an expansion bolt for installation.

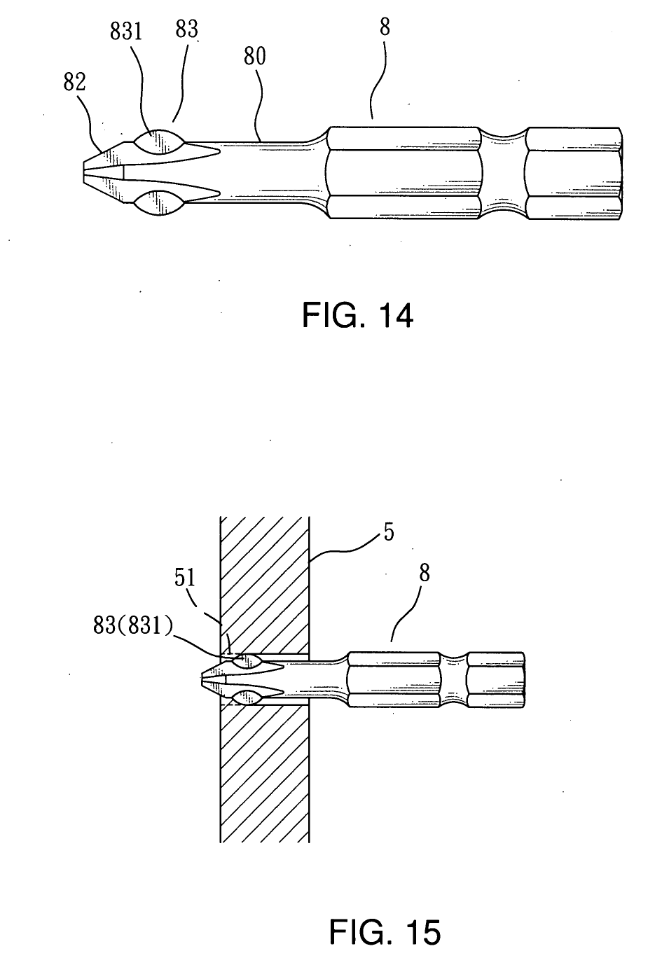

Refer to FIG. 14 for a third embodiment of the invention. An expansion bore cutting section 83 is formed on the surface of a shank 80 at the rear side of a directing section 82 of a bit 8, and includes at least one blade 831 jutting outwards with a cutting edge formed thereon. Referring to FIG. 17, when the bit 8 is used to form the working hole 51 on the wall panel 5, the expanding bore cutting section 83 with the blade 831 and the cutting edge formed thereon can perform drilling and cutting to form the working hole 51 to receive and install the expansion bolt.

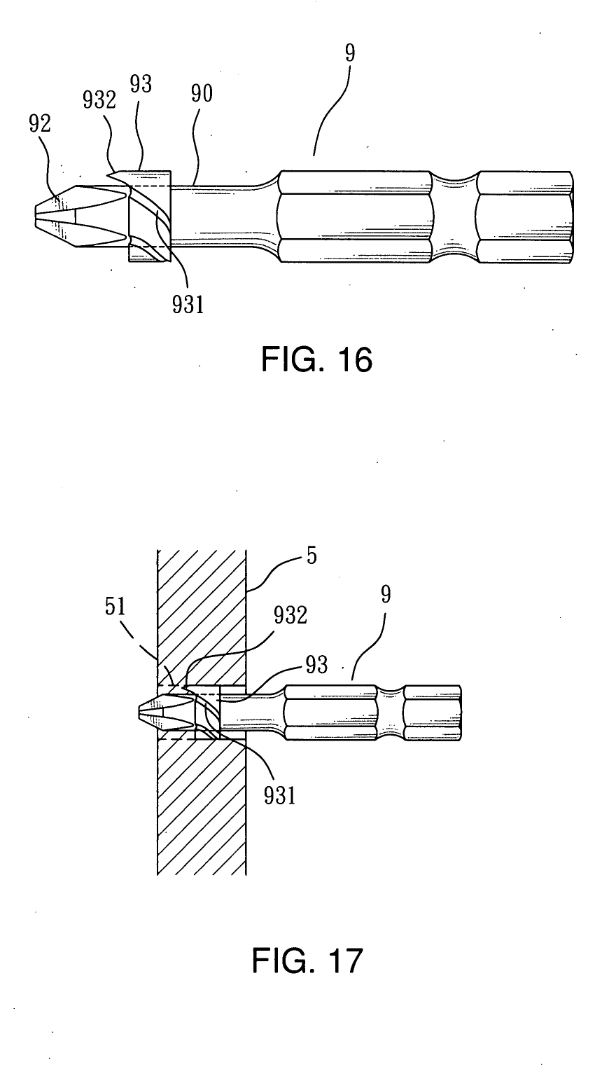

Refer to FIG. 16 for a fourth embodiment of the invention. An expansion bore cutting section 93 is formed at the rear side of a directing section 92. A jutting cutting edge 932 is formed at a front edge of one side of a shank 90 of a bit 9. The expansion bore cutting section 93 has at least one cut directing trough 931. Referring to FIG. 17, the cutting edge 932 can be used to cut and expand a hole, and perform drilling and cutting operations on the wall panel 5 to form the working hole 51 to receive and install an expansion bolt.

As a conclusion, the present invention can accomplish operations of drilling hole, expanding hole and fastening screws through a single bit, and effectively solve the disadvantages occurred to the conventional bits. It is a novel design and provides a significant improvement over the conventional products.

I claim:

1. A bit structure for powered tools comprising a shank action end at one end of a bit and a tool gripping section at another end thereof, the shank action end having a conical directing portion extended rearwards from a distal end thereof, wherein:
the directing portion is extended rearwards to form an expansion bore cutting section between the shank action end and the tool gripping section, the expansion bore cutting section having at least one axial cutting edge formed at a radial length equal to or greater than the maximum outer diameter of the directing portion.

2. The bit structure of claim 1, wherein the shank action end is formed in a shape mating a tool slot formed on a screw head of ordinary screws to fasten the screws.

3. The bit structure of claim 1, wherein the expansion bore cutting section has at least one cut directing trough originated from a ditch of the directing portion and extended rearwards to the expansion bore cutting section to form a debris discharge portion and a cutting edge formed at one side to perform cutting.

4. The bit structure of claim 3, wherein the cut directing trough is formed in a helical fashion on the surface of the expansion bore cutting section.

5. The bit structure of claim 1, wherein the expansion bore cutting section includes at least one blade jutting outwards from the surface of a shank of the bit that has the cutting edge formed thereon.

6. The bit structure of claim 1, wherein the expansion bore cutting section is located at a rear side of the directing portion and has a second directing portion extended from the surface of a shank of the bit and at least one cut directing trough for discharging debris and a cutting edge formed at one side to perform cutting.

7. The bit structure of claim 1, wherein the expansion bore cutting section is located at a rear side of the directing portion and a cutting edge jutting from a front edge of one side of a shank of the bit, and at least one cut directing trough.
